(19) United States
(12) Patent Application Publication
(10) Pub. No.: US 2018/0134575 A1
(43) Pub. Date: May 17, 2018

(54) PRODUCTION OF VCl4

(71) Applicant: CSIR, Pretoria (ZA)

(72) Inventors: David Steyn VAN VUUREN, Pretoria (ZA); Thebe Phillip MOKONE, Pretoria (ZA)

(21) Appl. No.: 15/576,192

(22) PCT Filed: May 12, 2016
(86) PCT No.: PCT/IB2016/052741

§ 371 Date: Nov. 21, 2017

(30) Foreign Application Priority Data
May 27, 2015 (ZA) 2015/03774

(51) Int. Cl. C01G 31/04

(52) U.S. Cl. CPC C01G 31/04

(57) ABSTRACT

A process (10) for the production of VCI₄ includes suspending a solid particulate oxygen-free vanadium compound starting material in a liquid reaction medium to form a reaction mixture, and reacting the oxygen-free vanadium compound starting material suspended in the liquid reaction medium with a chlorinating agent (18) to produce liquid VCI₄. The liquid reaction medium in the reaction mixture is maintained at a reaction temperature above its normal boiling point and the oxygen-free compound starting material and the chlorinating agent are reacted at a reaction pressure higher than the vapour pressure of the liquid reaction medium at the reaction temperature of the process so that the reaction mixture does not boil.

THIS INVENTION relates to production of VCl₄. In particular, the invention relates to a process for the production of VCl₄.

About 50% of the world market for titanium is for alloyed titanium. About 80% of the alloy market is for Ti6Al4V (Grade 5 alloy, i.e. an alloy containing 6% Al and 4% V). This can be produced using the blended elemental approach by mixing commercially pure grade Ti powder with AlV master alloy powder. However, the aluminium vanadium master alloy powder is expensive, products produced via the blended elemental approach have lower fatigue properties than products produced from pre-alloyed powder, the diffusion of V into Ti is retarded by Al and long sintering times are required. It is therefore desirable to produce pre-alloyed Ti powder containing vanadium. However, in 2015, the market for titanium vanadium powders such as pre-alloyed Ti6Al4V powder was very small due to the high cost of such powders. A large growth in the market is expected if such powders can be produced at a lower cost.

Pre-alloyed Ti powder containing V can in principle be produced by premixing TiCl₄ and VCl₄ (and AlCl₃ if desired) and then reducing the mixture together. However, the problem with this approach is that VCl₄ is a specialty product used as a catalyst for ethylene and propylene polymerization and the world market for it is extremely limited (in 2015 the world market for it was believed to be in the order of 150 tons per annum). Obtaining sufficient quantities of VCl₄ for a commercial scale Ti6Al4V plant (say 10000 tons per annum) would thus be difficult. In addition, VCl₄ is unstable and slowly decomposes to VCl₃ and Cl₂.

There is thus a need for a process for the production of VCl₄ in increased quantities that is commercially viable. It would be an advantage if such a process could produce oxygen-free VCl₄. It would also be an advantage if such a process has the potential to produce an admixture of VCl₄ and TiCl₄.

U.S. Pat. No. 6,423,291 describes a process for the production of TiCl₄ by chlorinating titanium values suspended in an inert liquid. VCl₄ is not mentioned as a product that can be produced in a similar way by the chlorination of suitable reagents.

U.S. Pat. No. 3,407,031 describes a process for the manufacture of chlorides of vanadium by chlorinating a mixture of a ferro-alloy, a carbide and a hard metal of vanadium with sodium chloride or chlorine or ferric chloride using NaFeCl₄ as a high temperature liquid medium under atmospheric pressure.

US 20110182787 describes a method for producing TiCl₄ by using a low grade titanium material capable of continuous industrialized production. The method is characterized in that the low grade titanium material containing a certain proportion of titanium carbide is caused directly to react with chlorine at 600-700° C. to produce the titanium tetrachloride. VCl₄ is not mentioned and the chlorination process occurs in the gas phase.

According to the invention, there is provided a process for the production of VCl₄, the process including
suspending a solid particulate oxygen-free vanadium compound starting material in a liquid reaction medium to form a reaction mixture; and
reacting the oxygen-free vanadium compound starting material suspended in the liquid reaction medium with a chlorinating agent to produce liquid VCl₄, the liquid reaction medium in the reaction mixture being at a reaction temperature above its normal boiling point and the oxygen-free compound starting material and the chlorinating agent being reacted at a reaction pressure higher than the vapour pressure of the liquid reaction medium at the reaction temperature of the process so that the reaction mixture does not boil.

By “oxygen-free vanadium compound starting material” is meant a starting material consisting essentially of a vanadium compound which does not include oxygen in its molecular or crystal structure, in contrast to a vanadium compound which does include oxygen in its molecular or crystal structure, such as VOCl₃ or V₂O₅. It is however not intended that the oxygen-free vanadium compound starting material must necessarily be entirely free of oxygen-containing materials or impurities. Although it is desirable to prevent oxygen ingress into the reaction environment, it will in practice in a commercial production facility be difficult, if not impossible, to ensure that the oxygen-free vanadium compound starting material does not include any compounds with oxygen.

As will be appreciated, with the reaction pressure being higher than the vapour pressure of the liquid reaction medium at the reaction temperature of the process, the liquid reaction medium is prevented from boiling, even at the commencement of the reaction of the oxygen-free vanadium compound starting material suspended in the liquid reaction medium with the chlorinating agent, i.e. even before the composition of the reaction mixture has changed significantly as a result of the production of liquid VCl₄. In fact, the reaction pressure is selected to be sufficiently high so that the reaction mixture, made up typically predominantly of the liquid reaction medium but including suspended solids material and eventually also produced liquid VCl₄, is prevented from boiling.

The oxygen-free vanadium compound starting material may be in a finely divided solid form, with a particle size that may be less than 3000 μm, preferably less than 100 μm, the starting material having an average particle size that may thus be in the range of 1-3000 μm, preferably 50-100 μm. The process may accordingly include, as a preliminary step, size reduction of a solid oxygen-free vanadium compound starting material, for example by milling, to achieve the above maximum and average particle sizes.

The reaction mixture may thus be in the form of a slurry comprising at least the liquid reaction medium and suspended particulate oxygen-free vanadium compound starting material, for example a slurry in which the suspended particles form 2-50% by volume, preferably 10-30% by volume.

The oxygen-free vanadium compound starting material may be selected from the group consisting of vanadium nitride, vanadium carbide, vanadium carbonitride, vanadium silicide, ferro vanadium, and mixtures of two or more thereof.

Preferably, the oxygen-free vanadium compound starting material is vanadium nitride or ferro vanadium.

By “liquid reaction medium” is meant a liquid which reacts unacceptably neither with the solid particulate oxygen-free vanadium compound starting material nor with any chlorinating agent (Le. a reductant) in the reaction mixture at the reaction temperature and the reaction pressure. The liquid reaction medium may thus be a fully chlorinated liquid, which is not prone to being further chlorinated. In some embodiments of the invention, the liquid reaction medium is an inert liquid.

The liquid reaction medium may be selected from the group consisting of liquid VCl₄, liquid TiCl₄ and mixtures thereof. VCl₄ is a bright red liquid with a normal boiling point of 154° C., whereas TiCl₄ is a light yellow coloured liquid with a normal boiling point of 136.4° C.

In principle, also CCl₄ may be used as liquid reaction medium. CCl₄ is also a colourless liquid but has a normal boiling point of 76.7° C. For a variety of reasons, including that it is also a chlorinating agent and that it has a relatively low normal boiling point, thus requiring a rather high reaction pressure to prevent it from boiling, the inventors however do not believe that CCl₄ will be practical in a commercial operation to produce VCl₄.

The chlorination reaction to produce VCl₄ is normally done at a temperature higher than the boiling points of the mentioned liquids, e.g. more than 140° C., or more than 160° C. preferably more than 170° C. and the process must therefore be operated at a pressure above atmospheric pressure to prevent boiling of the reaction mixture and hence complete evaporation of the liquid used as reaction medium. More specifically, if the operating temperature is 180° C., the pressure has to be higher than about 2.7 bar (absolute) and 1.9 bar (absolute) respectively when using TiCl₄ or VCl₄ as the liquid reaction medium.

Furthermore, the partial pressure of Cl₂ in the reactor has to be high enough to ensure that little or no solid VCl₃ is formed. This depends on the reactor operating temperature, the liquid reaction medium used and the concentration of VCl₄ dissolved in the liquid reaction medium, but in the case when VCl₄ is used as liquid reaction medium, the operating pressure has to be higher than about 6 bar (absolute) at minimum operating pressure conditions and higher than about 6.8 bar (absolute) at extremities of the more preferred reaction temperature range given below. As the temperature is increased the decomposition of liquid VCl₄ to solid VCl₃ and gaseous chlorine becomes less favourable, but the vapour pressure of VCl₄ increases. As a result, there is a minimum in the required operating pressure as the temperature is increased.

Preferably, the reaction temperature is no more than about 300° C., more preferably no more than about 220° C., e.g. between about 170° C. and about 220° C.

The reaction pressure may be at least about 2 bar (absolute), or at least about 3 bar (absolute), preferably at least about 4 bar (absolute), more preferably at least about 6 bar (absolute), e.g. about 7 bar (absolute). As indicated hereinbefore however, the reaction pressure selected will be dependent, inter alia, on the liquid reaction medium chosen and the concentration of produced VCl₄ in the liquid reaction medium. For example, when using TiCl₄ as liquid reaction medium and the concentration of VCl₄ dissolved in the TiCl₄ is kept low, i.e. in the order of 5 mol %, a reaction pressure of 2 bar (absolute) would from a thermodynamic point of view be sufficient.

In one embodiment of the invention, the reaction temperature is no more than 300° C. but at least 170° C. and the reaction pressure is at least 3 bar (absolute).

In a further embodiment of the invention, the reaction temperature is no more than 220° C. and the oxygen-free vanadium compound starting material is vanadium nitride or ferro vanadium.

Typically, the reaction mixture comprising the liquid reaction medium will include at least some of the VCl₄ produced. In other words, the VCl₄ produced is in liquid form and is typically admixed with the liquid reaction medium to form part of the reaction mixture, although, as will be appreciated, at least some of the VCl₄ produced may evaporate from the reaction mixture, with the extent of the evaporation depending on factors such as the reaction temperature, reaction pressure and concentration of VCl₄ in the reaction mixture. In any event, regardless of composition, the reaction mixture is prevented from boiling by selecting a suitable reaction temperature and a suitable reaction pressure elevated above atmospheric pressure.

The chlorinating agent may be chlorine or a suitable chlorine-containing compound, such as a chlorine-containing liquid or a chlorine-containing gas.

The chlorinating agent may be selected from the group consisting of HCl, CCl₄, SCl₂, Cl₂ and mixtures of two or more thereof.

The chlorinating agent may thus be a liquid, e.g. SCl₂, or the chlorinating agent may be a gas, e.g. HCl or molecular chlorine gas, i.e. Cl₂.

The chlorinating agent may be dispersed in the liquid reaction medium by dissolving it and/or dispersing or sparging globules or bubbles thereof in the liquid, conveniently under stirred and preferably turbulent conditions, to promote thorough mixing of the reaction mixture and contact between its reactive constituents, particularly between the solid particulate oxygen-free vanadium compound starting material and the chlorinating agent. In other words, the chlorinating agent may be dispersed as a disperse phase in the liquid reaction medium which forms a continuous phase, the liquid reaction medium being agitated to promote dispersion of the chlorinating agent therein; and the agitation may be such as to produce turbulent conditions in the liquid reaction medium to promote maintenance of a homogeneous reaction mixture and rapid reaction between the solid particulate oxygen-free vanadium compound starting material and the chlorinating agent.

Advantageously, the process of the invention employs relatively low reaction temperatures, allows good control of the highly exothermic chlorinating reaction(s) as the reaction(s) take(s) place in a liquid reaction medium, and has the potential to provide high yields as VCl₄ can be produced directly as a liquid rather than as a gas. The eventual reaction mixture, i.e. typically the chlorinated liquid reaction medium in admixture with VCl₄ produced and suspended unreacted solid particulate oxygen-free vanadium compound starting material, any solids residue, any chlorinating agent taken up by the liquid reaction medium and any by-products taken up by the liquid reaction medium, is easy to handle in a reactor, whether on a batch basis or on a continuous basis, and the process promises a reduction in chlorine losses and waste chlorine treatment compared to processes in which a liquid reaction medium is not employed. Importantly, when using a different liquid reaction medium than VCl₄ (for example liquid TiCl₄ or a mixture of liquid VCl₄ and liquid TiCl₄), VCl₃ may have a lower solubility in the liquid reaction medium than VCl₄ thus inhibiting decomposition of dissolved VCl₄ to VCl₃ during the process. Thus, in one embodiment of the invention, the liquid reaction medium is a liquid other than VCl₄, with VCl₃ and/or VCl₂ having a lower solubility in said liquid reaction medium than VCl₄.

The process may be conducted in a reactor on a batch basis, i.e. batch wise. Instead, the process may be conducted in a reactor on a continuous basis.

A feature of the process, whether conducted batch wise or on a continuous basis is that, at the relatively low reaction temperatures mentioned hereinbefore, impurities such as silicates and aluminates are not chlorinated to any significant extent. Furthermore, any metallic iron will tend to be chlorinated to either ferrous chloride or ferric chloride, i.e. FeCl₂ or FeCl₃, which have relatively low vapour pressures at the reaction temperatures mentioned hereinbefore, particularly if the reaction temperature is below 290° C. Relatively little FeCl₂ and FeCl₃ will thus issue from the reaction mixture as vapour with evaporated VCl₄ product, and the bulk thereof will remain dissolved in the reaction mixture where it forms a saturated solution, or will form a solid constituent attached to solids in the reaction mixture or slurry, issuing from the reactor as part of the solids residue, on which it can form a passivating layer.

The process may thus include withdrawing reaction mixture, which may include solids residue, from the reactor.

The process may include subjecting the reaction mixture to a separation operation. Thus, the process may include separating liquid VCl₄ from solids residue, e.g. by filtration. Advantageously, when the liquid reaction medium is VCl₄, no separation of liquid reaction medium and VCl₄ produced is required to produce a VCl₄ product.

The process may include recycling or pumping around the liquid reaction medium.

As mentioned hereinbefore, depending on factors such as the reaction temperature and the reaction pressure, a significant portion of the liquid VCl₄ formed in the reaction mixture may evaporate. The process may thus include condensing gaseous VCl₄ to provide condensed VCl₄.

The process may include returning condensed VCl₄ to the reaction mixture or to the reactor, i.e. to the reaction mixture.

Instead, condensed VCl₄ may be withdrawn from the reactor or process as a liquid VCl₄ product. In one embodiment of the invention, the liquid reaction medium is liquid TiCl₄ and the liquid VCl₄ that is produced is withdrawn as a liquid admixture of liquid VCl₄ and liquid TiCl₄.

Chlorine has a boiling point much lower than that of VCl₄ so that typically gaseous chlorine withdrawn from above the reaction mixture together with evaporated VCl₄ is not condensed with the VCl₄. The process may include recycling uncondensed chlorine to the liquid reaction medium, i.e. to the reaction mixture for reacting with the suspended solid particulate oxygen-free vanadium compound.

In one embodiment of the invention, the process thus includes withdrawing gaseous chlorinating agent from above the reaction mixture together with evaporated VCl₄, cooling the gaseous chlorinating agent during the condensing of the gaseous VCl₄ and recycling cooled chlorinating agent to the reaction mixture for reacting with the suspended solid particulate oxygen-free vanadium compound starting material, the cooled recycled chlorinating agent serving to at least assist in cooling the reaction mixture thereby to maintain the liquid reaction medium at a desired reaction temperature above the normal boiling point of the liquid reaction medium but with the reaction mixture not boiling.

The process may include purifying the VCl₄ produced. Purifying the VCl₄ produced may include subjecting the VCl₄ produced to a fractional distillation operation.

The process typically includes maintaining a positive Cl₂ pressure above the reaction mixture to limit co-production of undesirable by-products such as VCl₃ and VCl₂. Advantageously, VCl₃ and VCl₂ also have a lower solubility in the non-vanadium containing liquid reaction media mentioned hereinbefore (i.e. liquid TiCl₄) than VCl₄ thereby further limiting co-production of VCl₃ and VCl₂ in the reaction mixture.

When the process is carried out batch wise, in one embodiment of the process of the invention, it may be carried out in a reactor such as a temperature-controlled pressure vessel which is stirred or otherwise agitated, the pressure vessel containing a charge of liquid reaction medium and a charge of milled oxygen-free vanadium compound starting material, such as vanadium or vanadium carbide, together forming a reaction mixture or slurry. The slurry may be heated to a desired reaction temperature, with a chlorinating agent as hereinbefore described, e.g. molecular chlorine liquid or gas then being admitted to the pressure vessel until a desired reaction pressure is reached. The chlorine will act strongly exothermically with vanadium values in the oxygen-free vanadium compound starting material, to produce VCl₄. The reaction mixture or slurry in the vessel is prevented from boiling by maintaining a sufficiently high reaction pressure, with any VCl₄-containing vapour emanating from the reaction mixture being condensed in a reflux condenser and returned to the reaction mixture to prevent the temperature and pressure in the vessel from exceeding the desired reaction temperature and desired reaction pressure respectively. The reaction mixture is eventually withdrawn from the reactor, cooled and separated to produce a liquid VCl₄ product and a solids residue.

When the process is carried out batch wise, in another embodiment of the process of the invention, it may be carried out in a reactor such as a temperature-controlled pressure vessel which is stirred or otherwise agitated, the pressure vessel containing a charge of liquid reaction medium and a charge of milled oxygen-free vanadium compound starting material, such as vanadium, ferro vanadium or vanadium carbide, together forming a reaction mixture or slurry. The slurry may be heated to a desired reaction temperature, with a chlorinating agent as hereinbefore described, e.g. molecular chlorine liquid or gas then being admitted to the pressure vessel until a desired reaction pressure is reached. The chlorine will act strongly exothermically with vanadium values in the oxygen-free vanadium compound starting material, to produce VCl₄. The reaction mixture or slurry in the vessel is prevented from boiling by maintaining a sufficiently high reaction pressure, with any VCl₄-containing vapour emanating from the reaction mixture being condensed in a condenser with uncondensed, cooled chlorinating agent being recycled to the reaction mixture and condensed VCl₄ being withdrawn as a liquid VCl₄ product, with the cooled, recycled chlorinating agent and withdrawal of the condensed VCl₄ product serving to prevent the temperature and pressure in the vessel from exceeding the desired reaction temperature and desired reaction pressure respectively. The reaction mixture is eventually filtered to remove any solids residue and returned to the reactor for a subsequent batch operation.

When the process is carried out batch wise, in yet another embodiment of the process of the invention, it may be carried out in a reactor such as a temperature-controlled pressure vessel which is stirred or otherwise agitated, the pressure vessel containing a charge of liquid reaction medium and a charge of milled oxygen-free vanadium compound starting material, such as vanadium nitride or vanadium carbonitride, together forming a reaction mixture or slurry. The slurry may be heated to a desired reaction temperature, with a chlorinating agent as hereinbefore described, e.g. molecular chlorine liquid or gas then being admitted to the pressure vessel until a desired reaction pressure is reached. The chlorine will act strongly exothermically with vanadium values in the oxygen-free vanadium compound starting material, to produce VCl₄. The reaction mixture or slurry in the vessel is prevented from boiling by maintaining a sufficiently high reaction pressure, with VCl₄-containing vapour emanating from the reaction mixture being subjected to a product recovery stage to recover VCl₄ product. Gaseous chlorinating agent withdrawn from a head space above the slurry with the gaseous VCl₄ is subjected to a chlorine separation stage, after having passed through the product recovery stage, to separate chlorine from any off-gas, and the gaseous chlorine is recycled to the reaction mixture, with the cooled, recycled chlorinating agent and withdrawal of the separated liquid VCl₄ product serving to prevent the temperature and pressure in the vessel from exceeding the desired reaction temperature and desired reaction pressure respectively. The reaction mixture is eventually filtered to remove any solids residue and returned to the reactor for a subsequent batch operation.

As will be appreciated, although VCl₄ is produced directly as a liquid in the liquid reaction medium, typically as a result of a solids-gas reaction in the liquid reaction medium, any vented VCl₄ withdrawn from a head space above the slurry can be regarded as product and can be condensed and separated from other constituents of the vented vapour, such as chlorine gas and other gases or vapours, the chlorine optionally being recovered for subsequent use in chlorinating another batch of starting material. Solid residues will remain in the pressure vessel or reactor, typically suspended in the liquid reaction medium. The aforesaid batch reaction cycle can then be repeated, by loading a fresh charge of oxygen-free vanadium compound starting material into the vessel and chlorinating it as set forth above. Accumulated solid residues can be cleared periodically from the vessel, and the charge of liquid reaction medium can be discarded and replaced, if and when it becomes unacceptably contaminated by dissolved or suspended impurities.

When the process is carried out continuously, in a further embodiment of the process of the invention, a solid particulate oxygen-free vanadium compound starting material, milled to a desired maximum particle size and with a desired average particle size, is mixed with a liquid reaction medium such as TiCl₄ to form a slurry in which the solid material forms say 10-30% by volume. The slurry may then be heated to a temperature preferably of at least 170° C. as for batch operation and transferred, e.g. by pumping, as a slurry feed to a suitable reactor operating preferably at at least 170° C. such as a temperature-controlled pressure vessel which is agitated, for example an upflow slurry bubble-column reactor which may be fitted with baffles to resist back mixing and to the bottom of which liquid or gaseous molecular chlorine is introduced as chlorinating agent, e.g. via a sparger. As is the case with batchwise operation, the introduced chlorine reacts with vanadium values, in strongly exothermic fashion, to produce VCl₄ in the slurry as a liquid. The reaction mixture or slurry in the vessel is prevented from boiling by maintaining a sufficiently high reaction pressure, with any VCl₄-containing vapour emanating from the reaction mixture being condensed in a reflux condenser and returned to the reaction mixture (e.g. directly into the slurry feed, directly into the reactor or indirectly via a mixing step where the slurry feed is formed) to prevent the temperature and pressure in the vessel from exceeding the desired reaction temperature and desired reaction pressure respectively. Instead, the reaction mixture or slurry in the vessel is prevented from boiling by maintaining a sufficiently high reaction pressure, with any VCl₄-containing vapour emanating from the reaction mixture being condensed in a condenser with uncondensed, cooled chlorinating agent being recycled to the reaction mixture and condensed VCl₄ being withdrawn as a liquid VCl₄ product, with the cooled, recycled chlorinating agent and withdrawal of the condensed VCl₄ product serving to prevent the temperature and pressure in the vessel from exceeding the desired reaction temperature and desired reaction pressure respectively. In yet a further possible embodiment, the reaction mixture or slurry in the vessel is prevented from boiling by maintaining a sufficiently high reaction pressure, with VCl₄-containing vapour emanating from the reaction mixture being subjected to a product recovery stage to recover VCl₄ product. Gaseous chlorinating agent withdrawn from a head space above the slurry with the gaseous VCl₄ is subjected to a chlorine separation stage, after having passed through the product recovery stage, to separate chlorine from off-gas, and the gaseous chlorine is recycled to the reaction mixture, with the cooled, recycled chlorinating agent and withdrawal of the separated VCl₄ product serving to prevent the temperature and pressure in the vessel from exceeding the desired reaction temperature and desired reaction pressure respectively. The liquid reaction medium (if a substance other than VCl₄ is used therefor) may be condensed and recycled to the reactor. Non-condensable gases from this partial condensation may, after extraction of any residual VCl₄ or chlorine gas therefrom, be discarded as off-gas, the extracted VCl₄ and chlorine optionally being recycled to the reactor.

Spent slurry withdrawn from the top of the reactor may have the VCl₄ contained therein recovered, e.g. by filtration, the filtrate being VCl₄ which may be recycled to the initial slurry-forming mixing step, or to the slurry formed in the initial mixing step. Filter cake from the filtration step may then be dried, dried filter cake being subjected to waste treatment, e.g. to recover or neutralize salts such as FeCl₂ or FeCl₃ therein, before being discarded, and VCl₄ from the drying may be recovered and recycled together with the recycled filtrate.

When the chlorinating agent is fed into the reaction mixture, the rate of feeding of the chlorinating agent may be manipulated to control the reaction pressure.

The invention extends to VCl₄ produced in accordance with the process of the invention.

The invention will now be described, by way of example, with reference to the accompanying diagrammatic drawings in which

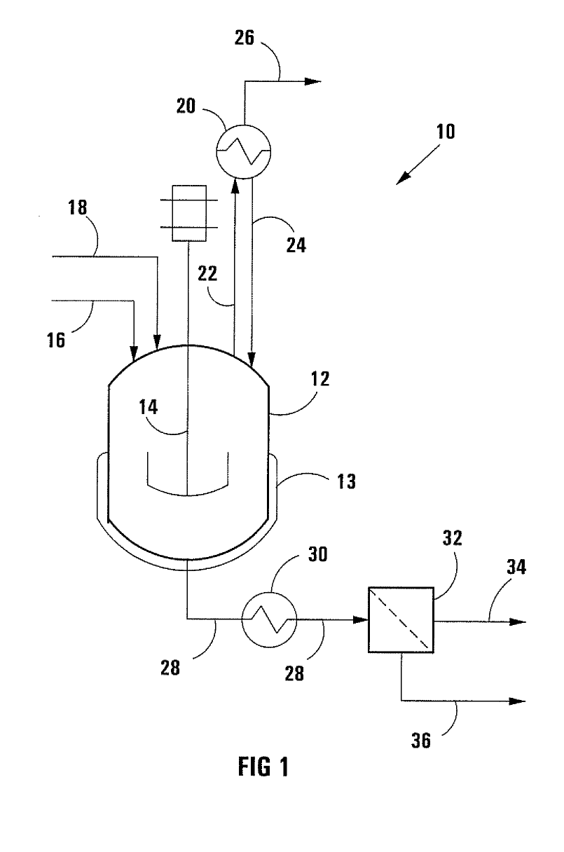

FIG. 1 shows one embodiment of a process in accordance with the invention for the production of VCl₄;

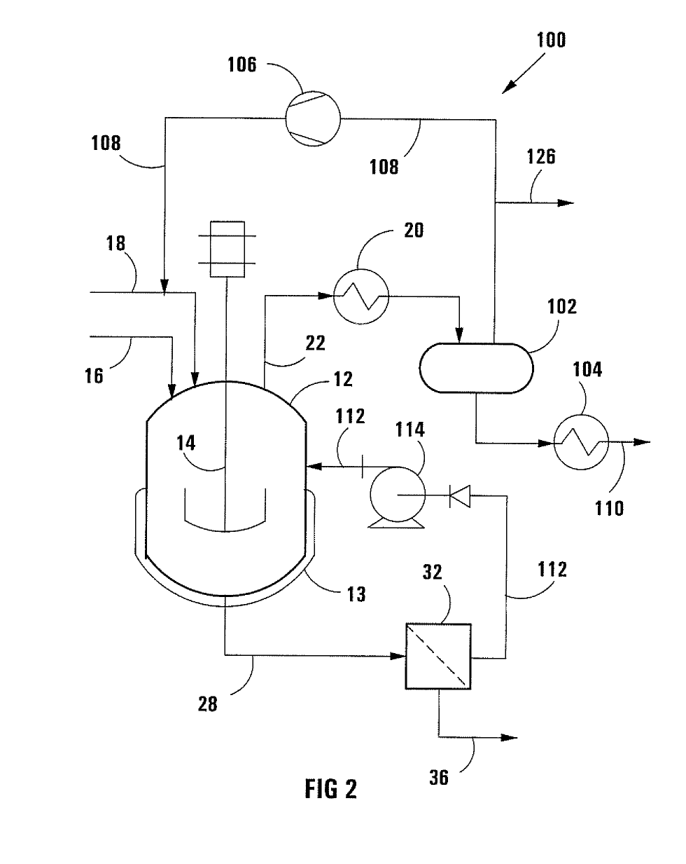

FIG. 2 shows another embodiment of a process in accordance with the invention for the production of VCl₄; and

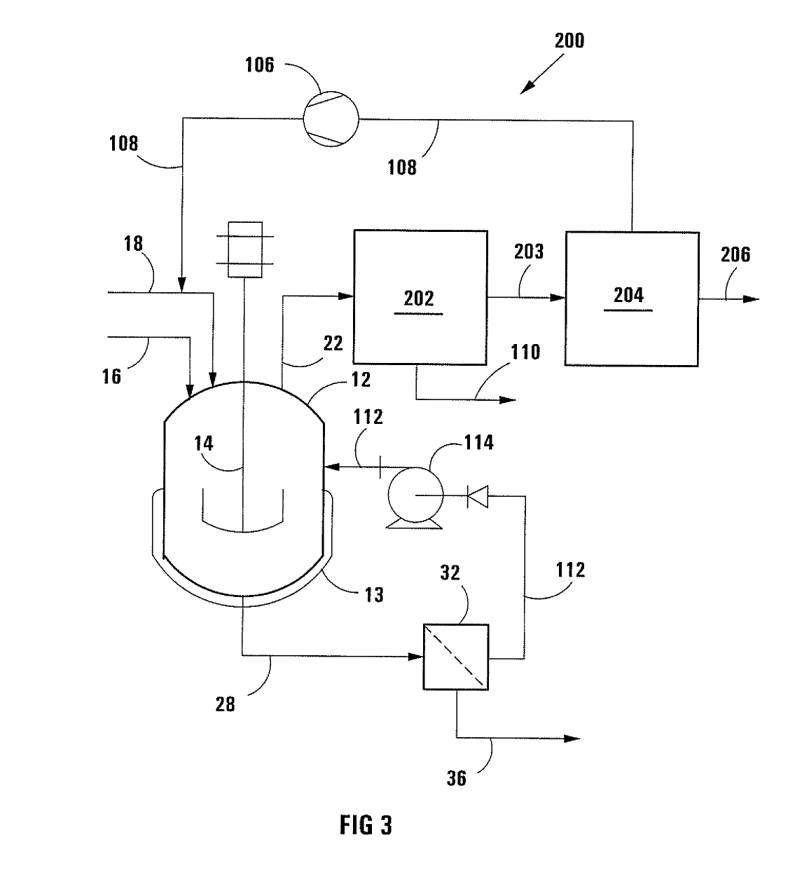

FIG. 3 shows yet another embodiment of a process in accordance with the invention for the production of VCl₄.

Referring to FIG. 1 of the drawings, reference numeral 10 generally indicates a process in accordance with the invention for the production of VCl₄. The process 10 includes broadly a reactor 12 with an electrically driven agitator or stirrer 14. The reactor 12 is thus a stirred reactor and is temperature controlled, or at least heated, by means of a heating jacket 13 which may for example employ steam as a heating medium. The reactor 12 is provided with a feed line 16 and a chlorinating agent line 18. A reflux condenser 20 is in flow communication with the reactor 12 by means of a vapour withdrawal line 22 and a condensate return line 24. The reflux condenser 20 is also provided with a bleed line 26.

A reaction mixture withdrawal line 28 leads from the reactor 12 to a cooler 30 and from the cooler 30 to a filter 32. A product line 34 and a residue line 36 leave the filter 32.

The process 10 is typically conducted on a batch basis. The reactor 10 is thus loaded with a quantity of liquid VCl₄ as a liquid reaction medium and suspended powdered vanadium and/or vanadium carbide as a starting material. This can be done consecutively by first feeding the liquid VCl₄ through the feed line 16 into the reactor 12, then feeding the powdered starting material into the reactor 12 by means of the feed line 16, and then suspending the starting material in the liquid VCl₄ by using the stirrer 14. Alternatively, the powdered vanadium or vanadium carbide starting material can be suspended in the liquid VCl₄ to form a slurry, with the slurry then being fed into the reactor 12 by means of the feed line 16.

Typically, the powdered vanadium or vanadium carbide starting material has a particle size of about 50-100 μm and the slurry contains about 10-30% by volume of the starting material. The powdered vanadium or vanadium carbide starting material is substantially oxygen free, in the sense that the starting material does not include a vanadium compound, or does not include a significant amount of a vanadium compound, such as V₂O₅, which includes oxygen in its molecular or crystal structure.

The slurry of liquid VCl₄ and suspended oxygen-free vanadium compound starting material forms a reaction mixture and is heated under stirring in the reactor 12 by means of the heating jacket 13 to a temperature of about 200° C. Chlorine gas as a chlorinating agent is then fed into the reactor 12 through the chlorinating agent line 18 and the reactor 12 is pressure controlled to maintain a reaction pressure of about 7 bar (absolute). Preferably, the chlorinating agent, when in gaseous form, is bubbled through the reaction mixture whilst the stirrer 14 is employed to maintain the oxygen-free vanadium compound starting material in suspension and to disperse the chlorinating agent in the reaction mixture.

The vanadium in the oxygen-free vanadium compound starting material suspended in the liquid reaction medium (liquid VCl₄) is thus chlorinated to produce more liquid VCl₄ which is taken up by the reaction mixture. The chlorinating reaction is strongly exothermic. The reaction mixture in the reactor 12 is prevented from boiling by employing a reaction pressure above atmospheric pressure and by withdrawing gas comprising chlorine and evaporated gaseous VCl₄ from a head space above the reaction mixture, cooling and hence condensing the gas in the reflux condenser 20 and returning VCl₄ condensate, which may include dissolved chlorine, to the reaction mixture in the reactor 12. A small bleed is taken from the reflux condenser 20 by means of the bleed line 26 to prevent accumulation of inert gas at the top of the condenser, in particular N₂ which may be present in the process 10 when starting up the process.

By means of the returned condensate, the temperature of the reaction mixture in the reactor 12 is controlled or at least reduced, whereas the chlorine feed is used to control the reaction pressure. If necessary or desirable, the reactor 12 can employ additional cooling means, such as cooling coils or the jacket 13 and a cooling utility such as cooling water to control the reaction temperature.

Once the reaction has progressed to convert substantially all of the vanadium in the starting material to liquid VCl₄, the reaction mixture is withdrawn by means of the reaction mixture withdrawal line 28, cooled in the cooler 30 and filtered in the filter 32 to produce liquid VCl₄ as a product, which is then withdrawn by means of the product line 34, and a solids residue which is withdrawn by means of the residue line 36. The reactor 12 can be depressurised by means of the bleed line 26. The solids residue may include compounds such as FeCl₂ or FeCl₃ formed in the reaction mixture from ferrous substances present in the starting material, or impurities such as silicates and aluminates introduced into the reaction mixture as part of the oxygen-free vanadium compound starting material. The solids residue may also include VCl₃, formed by decomposition of VCl₄ in the reactor 12. The formation of VCl₃ can be limited by maintaining a positive chlorine pressure in the reactor 12, by limiting the reaction temperature and by employing a liquid reaction medium in which VCl₃ is less soluble than VCl₄.

If desired or necessary, the process 10 includes distilling (not shown) the VCl₄ product to purify or concentrate the VCl₄.

Referring to FIG. 2 of the drawings, another embodiment of a process in accordance with the invention for the production of VCl₄ is shown and generally indicated by reference numeral 100. The process 100 is similar to the process 10 and unless otherwise indicated, the same reference numerals used for the process 10 are used to indicate the same or similar process features in the process 100.

The process 100 differs from the process 10 in that the condenser 20 is not a reflux condenser but a partial condenser. The process 100 further includes a hot drum 102 and a product cooler 104, with a recycle blower 106 being provided in a chlorinating agent recycle line 108, from which the bleed line 26 splits off. The hot drum 102 is also provided with a product line 110, with the product cooler 104 being located in the product line 110.

A reaction mixture recycle line 112 returns from the filter 32 to the reactor 12 and is provided with a recycle pump 114.

In the process 100, vanadium, ferro vanadium and/or vanadium carbide is used as an oxygen-free vanadium compound starting material, whereas liquid TiCl₄ and not liquid VCl₄ is used as the liquid reaction medium. Chlorine gas is used as the chlorinating agent.

The reactor 12 is also operated on a batch basis but starts with a charge of recycled or re-used liquid TiCl₄ as the liquid reaction medium. Suspended powdered vanadium, ferro vanadium and/or vanadium carbide as an oxygen-free vanadium compound starting material is charged into the reactor as hereinbefore described with reference to the process 10. Again, chlorine gas is used as the chlorinating agent.

The reactor 12 is operated at a reaction temperature of about 180° C. and a reaction pressure of about 8 bar (absolute). At these conditions, evaporation of produced VCl₄ (and also TiCl₄) from the reaction mixture is significant, even though the reaction mixture is prevented from boiling. Evaporated VCl₄ and TiCl₄ and also unreacted chlorine gas are withdrawn by means of the vapour withdrawal line 22 and partially condensed in the condenser 20. VCl₄-containing condensate (which also includes TiCl₄) and uncondensed gas (mostly chlorine) are separated in the hot drum 102 with the VCl₄-containing condensate then being withdrawn by means of the product line 110, cooled in the product cooler 104 and delivered as a cooled liquid VCl₄-containing product. Uncondensed chlorinating agent, i.e. chlorine gas is withdrawn from the hot drum 102 and recycled by means of the chlorinating agent recycle line 108 and the recycle blower 106 to the chlorinating agent line 18 for return to the reactor 12.

As in the case of the process 10, the bleed line 26 is used to release inert gas from the process, in particular N₂ which may be present in process 100 when starting up the process.

If desired or necessary, the process 100 includes distilling (not shown) the VCl₄-containing product to purify or concentrate the VCl₄. Instead, the VCl₄-containing product, which is an admixture of VCl₄ and TiCl₄, can be used directly to produce vanadium-containing Ti alloy.

Once the reaction has substantially progressed to completion, the reaction mixture is withdrawn from the reactor 12 by means of the reaction mixture withdrawal line 28, filtered to remove solids residue by means of the residue line 36, and returned to the reactor 12 by means of the reaction mixture recycle line 112 and the recycle pump 114 for use with the next batch of vanadium-containing starting material.

Thus, as will be appreciated, in the process of FIG. 2, although VCl₄ is produced as liquid in the reaction mixture, the VCl₄ is allowed to evaporate and is withdrawn from the reactor 12 as a gas, before being condensed and reproduced as a liquid product, which includes TiCl₄.

FIG. 3 shows a further embodiment of a process in accordance with the invention for producing VCl₄. The process is generally indicated by reference numeral 200 and again the same reference numerals as were used in FIGS. 1 and 2 are used in FIG. 3 to indicate the same or similar process features, unless otherwise indicated.

In the process of FIG. 3, vanadium nitride or vanadium carbonitride are used as the solid particulate oxygen-free vanadium compound starting material whereas recycled liquid TiCl₄ is used as the liquid reaction medium and chlorine gas is used as the chlorinating agent.

The reactor 12 starts with a charge of recycled or re-used liquid TiCl₄ as the liquid reaction medium. Suspended powdered vanadium nitride and/or vanadium carbonitride as a starting material is charged into the reactor as hereinbefore described with reference to the process 10. The reactor 12 is operated on a batch basis at a reaction temperature of about 180° C. and a reaction pressure of about 8 bar (absolute).

As is the case with the process 100, operating conditions are selected such that significant quantities of TiCl₄ and of the liquid VCl₄ produced in the reaction mixture as a result of the chlorination of the oxygen-free vanadium compound starting material by the chlorine gas are allowed to evaporate and are withdrawn by means of the vapour withdrawal line 22. The withdrawn vapour is then however subjected to a product recovery stage 202 in which liquid VCl₄ and liquid TiCl₄ are separated from other components withdrawn by means of the vapour withdrawal line 22 and then produced as a liquid VCl₄-containing product (which also includes TiCl₄) withdrawn by means of the product line 110. The recovery stage 202 consists essentially of a condenser cooler and cold liquid collection drum.

Gaseous components are withdrawn from the product recovery stage 202 by means of a transfer line 203 and are fed into a Cl₂ separation stage 204 where Cl₂ is separated from other gases, in particular nitrogen which is produced as a by-product when chlorinating vanadium nitride or vanadium carbo-nitride and returned by means of the chlorinating agent recycle line 108 to the chlorinating agent line 18 and hence to the reactor 12. Gaseous by-products such as N₂ are withdrawn from the Cl₂ separation stage 204 by means of an off-gas line 206. The Cl₂ separation stage 204 may consist of a VCl₄ and TiCl₄ scrubbing column or columns followed by a refrigeration unit to condense and separate the bulk of unreacted chlorine from the nitrogen before recycling the chlorine to the reactor 12.

As is the case with the process 100, in the process 200 the reaction mixture, once the reaction has progressed to completion, is withdrawn by means of the reaction mixture withdrawal line 28, separated in the filter 32 to remove solids residue from the reaction mixture, and returned to the reactor 12 by means of the reaction mixture recycle line 112 and the recycle pump 114 for use with the next batch of oxygen-free vanadium-containing starting material.

The process of the invention, as illustrated, advantageously employs relatively low reaction temperatures, allows good control of the highly exothermic chlorinating reaction(s) as the reaction(s) take(s) place in a liquid reaction medium, and has the potential to provide high yields as VCl₄ can be produced directly as a liquid rather than as a gas. The reaction mixture is easy to handle in a reactor, whether on a batch or continuous basis, and the process promises a reduction in chlorine losses and waste chlorine treatment compared to processes in which a liquid reaction medium is not employed. As it is possible to select a liquid reaction medium in which VCl₃ has a lower solubility than VCl₄, decomposition of VCl₄ to VCl₃ during the process of the invention, as illustrated, is advantageously inhibited.

1. A process for the production of VCl₄, the process including
suspending a solid particulate oxygen-free vanadium compound starting material in a liquid reaction medium to form a reaction mixture; and
reacting the oxygen-free vanadium compound starting material suspended in the liquid reaction medium with a chlorinating agent to produce liquid VCl₄, the liquid reaction medium in the reaction mixture being at a reaction temperature above its normal boiling point and the oxygen-free compound starting material and the chlorinating agent being reacted at a reaction pressure higher than the vapour pressure of the liquid reaction medium at the reaction temperature of the process so that the reaction mixture does not boil.

2. The process as claimed in claim 1, in which the oxygen-free vanadium compound starting material is selected from the group consisting of vanadium nitride, vanadium carbide, vanadium carbonitride, vanadium silicide, ferro vanadium, and mixtures of two or more thereof.

3. The process as claimed in claim 1, in which the liquid reaction medium is a fully chlorinated liquid, which is not prone to being further chlorinated.

4. The process as claimed in claim 1, in which the liquid reaction medium is selected from the group consisting of liquid VCl₄, liquid TiCl₄, and mixtures thereof.

5. The process as claimed in claim 1, in which the reaction temperature is no more than 300° C. but at least 140° C. and in which the reaction pressure is at least 2 bar (absolute).

6. The process as claimed in claim 1, in which the chlorinating agent is selected from the group consisting of HCl, CCl₄, SCl₂, Cl₂ and mixtures of two or more thereof.

7. The process as claimed in claim 1, in which at least a portion of the liquid VCl₄ formed in the reaction mixture evaporates, the process including condensing at least some of the gaseous VCl₄ to provide condensed VCl₄, the condensed VCl₄ being withdrawn as a liquid VCl₄ product or the condensed VCl₄ being returned to the reaction mixture.

8. The process as claimed in claim 7, which includes withdrawing gaseous chlorinating agent from above the reaction mixture together with evaporated VCl₄, cooling the gaseous chlorinating agent during the condensing of the gaseous VCl₄ and recycling cooled chlorinating agent to the reaction mixture for reacting with the suspended solid particulate oxygen-free vanadium compound starting material, the cooled recycled chlorinating agent serving to at least assist in cooling the reaction mixture thereby to maintain the liquid reaction medium at a desired reaction temperature above the normal boiling point of the liquid reaction medium but with the reaction mixture not boiling.

9. The process as claimed in claim 1, which includes maintaining a positive Cl₂ pressure above the reaction mixture to limit co-production of VCl₃ and VCl₂ as undesirable by-products.

10. The process as claimed in claim 5, in which the reaction temperature is no more than 220° C. and in which the oxygen-free vanadium compound starting material is vanadium nitride or ferro vanadium.

11. The process as claimed in claim 1, in which the liquid reaction medium is liquid TiCl₄ and in which the liquid VCl₄ that is produced is withdrawn as a liquid admixture of liquid VCl₄ and liquid TiCl₄.

12. The process as claimed in claim 5, in which the reaction pressure is at least 6 bar (absolute).

13. The process as claimed in claim 1, in which the liquid reaction medium is a liquid other than VCl₄ and in which VCl₃ and/or VCl₂ has a lower solubility than VCl₄.

14. The process as claimed in claim 1, in which the chlorinating agent is fed into the reaction mixture, the rate of feeding of the chlorinating agent being manipulated to control the reaction pressure.

15. VCl₄ produced in accordance with the process of claim 1.
